(19) United States
(12) Patent Application Publication
(10) Pub. No.: US 2023/0153712 A1
(43) Pub. Date: May 18, 2023

(54) EVALUATION PLATFORM AS A SERVICE

(71) Applicant: SAP SE, Walldorf (DE)

(72) Inventor: Showkath Ali Naseem, Anantapur (IN)

(21) Appl. No.: 17/528,772

(22) Filed: Nov. 17, 2021

(51) Int. Cl. G06Q 10/06; G06Q 10/10

(52) U.S. Cl. CPC G06Q 10/063112; G06Q 10/063114; G06Q 10/1053

(57) ABSTRACT

A method, a system, and a computer program product for enabling development testing during evaluation processes. A request to complete one or more computing tasks for executing by at least one computing system is received. A development interface associated with the computing system for developing one or more responses to the received request is generated. A completion of the computing tasks includes the developed responses. One or more computing applications for developing the responses associated with the computing tasks are accessed based on the received request. The computing tasks are completed in the development interface by executing the accessed computing applications associated with the developing of the responses by the computing system and are transmitted.

### TECHNICAL FIELD

This disclosure relates generally to data processing and, in particular, to provide a computing environment for enabling development testing during evaluation processes.

### BACKGROUND

Many companies rely on software applications to conduct their business. Software applications deal with various aspects of companies' businesses, which can include finances, product development, human resources, customer service, management, and many other aspects. Software applications typically operate from servers and can be stored in memory. To use software applications, users typically employ various computing devices. User interfaces provide users with an ability to provide instructions to software applications, interact with other users, and perform various functionalities in furthering their company's business. User interfaces can include a variety of software tools that can be generated by the corresponding software applications. The tools can assist users with performing their tasks, such as word processing, graphics creation, application development, etc. It is important to be able to provide interfaces that enable development, execution, and evaluation of work by various users, such as, during a hiring process.

### SUMMARY

In some implementations, the current subject matter relates to a computer implemented method for enabling development testing during evaluation processes. The method may include receiving a request to complete one or more computing tasks for executing by at least one computing system, and generating a development interface associated with the computing system for developing one or more responses to the received request. A completion of the computing tasks may include the developed responses. The method may also include accessing, based on the received request, one or more computing applications for developing the responses associated with the computing tasks, completing the computing tasks, in the development interface, by executing the accessed computing applications associated with the developing of the responses by the computing system, and transmitting the completed tasks.

In some implementations, the current subject matter may include one or more of the following optional features. The development interface may be a browser-based interface. One or more tasks may include at least one of the following: generating a source code, generating one or more computing functions, generating one or more software applications, generating one or more computing functionalities, providing at least one of a text, graphical, audio, video and image data, and any combination thereof.

In some implementations, accessing may include accessing at least one of the following: one or more source code libraries, one or more computing applications external to the development interface, one or more computing applications internal to the development interface, and any combination thereof for developing one or more responses.

In some implementations, receiving may include receiving, from a first user, the request to complete one or more computing tasks for executing by at least one computing system, and assigning the received request to at least one second user for completion. The method may also include authenticating, using the development interface, the first and second users. In some implementations, the computing system may be a cloud-based computing system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for conducting various recruiting activities, according to some implementations of the current subject matter;

FIG. 2 is a flow chart illustrating an exemplary process for operating the development environment, according to some implementations of the current subject matter;

FIG. 3 is a diagram illustrating an exemplary system including a data storage application, according to some implementations of the current subject matter;

FIG. 4 is a diagram illustrating details of the system of FIG. 3;

FIG. 5 is an exemplary system, according to some implementations of the current subject matter; and

FIG. 6 is an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that may, in some implementations, provide a computing environment for enabling development testing during evaluation (e.g., candidate interview) processes.

In some implementations, the current subject matter may be configured to provide a computing environment (e.g., a platform-as-a-service) that may be used for testing, development, etc. of capabilities of various users during, for example, interviews. Such platform-as-a-service (PaaS) may be configured to have a development environment that may include one or more computing tools (e.g., functionalities, software applications, etc.) that may be integrated into the development environment for use by one or more users. Using the PaaS, various users may generate various requests for creating and/or developing of applications, functionalities, functions, etc. that may be created/developed by other users using tools and/or libraries that may be available from the PaaS. Users may be configured to control development, configuration, testing, execution, etc. of the developed applications, functionalities, functions, etc. The development environment may provide and/or otherwise be communicatively coupled with networks, servers, storage, and/or other services that may be required for creation/development of applications, functionalities, functions, etc. The PaaS may include applications, functionalities, functions, etc. design, development, testing, deployment, as well as various services, including, for example, team collaboration, web service integration, marshalling, database integration, security, scalability, storage, persistence, state management, application versioning, application instrumentation, and others.

In some implementations, the development environment may be configured as an interviewing platform that may be used for screening prospective candidates and/or testing their skills. The environment may be accessible by various types of users, including, for example, interviewer users, prospective candidate users, administrator users, and/or any other types of users. For any prospective candidate users, the development environment may be configured to generate and/or provide various requests to prospective candidate users. The request may be automatically generated and/or may originate from one or more interviewer users (and/or any other users). The requests may include one or more questions about the prospective candidate users, e.g., questions relating to candidate user's background information, employment history, etc. Moreover, the requests may include one or more assignments to complete a particular task, e.g., write a code for a function that may be used for a particular purpose. In resolving the task, the candidate user may implement any tools that may be available in the development environment, may request access to one or more tools, datasets, etc. that may be needed to complete the task. The candidate user may also use one or more test operability of the completed task (e.g., software application, functionality, function, etc.). In some implementations, the completed task may be tested in a closed environment, e.g., without access to live data and/or applications. Alternatively, or in addition to, the completed task may be tested using live data and/or applications without altering integrity, current operation, etc. of such live data and/or applications.

Additionally, the development environment may also provide connectivity among various users using various online media platforms. Using such platforms, users are able to conduct virtual in-person discussions, assess viability of the prospective candidates, complete various questionnaires, generate assessments relating to the prospective candidates, etc.

In some implementations, the development environment may be configured to provide a runtime environment for executing a sequence of tasks, e.g., as may be associated with evaluation of prospective candidates for employment at a company. Such tasks may be executed in synchronous, asynchronous, and/or any other desired manner. The development environment may be configured to receive, as an input, one or more requests, assignments, configuration data, etc. for evaluation of a candidate user. To respond to such requests, assignments, etc., the candidate user may be configured to perform various processes (e.g., write code, assemble various functionalities, etc.). One or more such processes may be executed at the same time using the development environment. Alternatively, or in addition to, the processes may be executed, using the development environment, in a particular execution order. The development environment may also be configured to provide for external communications, such as, for example, query execution, invoking application programming interface (API) calls, etc.

In some implementations, the development environment may be configured to generate a user interface that may allow dragging and dropping of various functionalities, computing applications, etc. for the purposes of answering specific requests, e.g., generating computing functionalities, functions, etc. The user interface may include one or more graphical panels that may include a listing of available functionalities, functions, and/or components (e.g., functionalities, computing blocks, data, metadata, etc.) that may be available for selection. The user interface may also include a “canvas” area that may be used for responding to requests. One or more candidate users may use the user interface to perform various functionalities associated with generation of responses to requests. The development environment may be configured to provide one or more templates (e.g., predefined structures) for generating responses to requests.

By way of a non-limiting example, using the user interface of the development environment, candidate users may select one or more pre-defined computing components from one or more user interface panels and then drag-and-drop the components into the development environment's canvas area. In some implementations, the development environment may be configured to provide a compiling functionality of any applications, functionalities, functions, etc. generated by the candidate users to ensure that such applications, functionalities, functions, etc. are capable of operating a mock production environment, e.g., capable of operating in accordance with various requirements of computing systems where the generated applications, functionalities, functions, etc. may be implemented.

In some implementations, the development environment may be communicatively coupled to a storage location and/or a database to store result(s) of compiling of each applications, functionalities, functions, etc., process and store data that may result from execution of applications, functionalities, functions, etc., and/or store any other data. The storage location may be configured to store results of execution of one or more or a chain of generated applications, functionalities, functions, etc., where one applications, functionalities, functions, etc. may require resulting data from execution of another applications, functionalities, functions, etc.

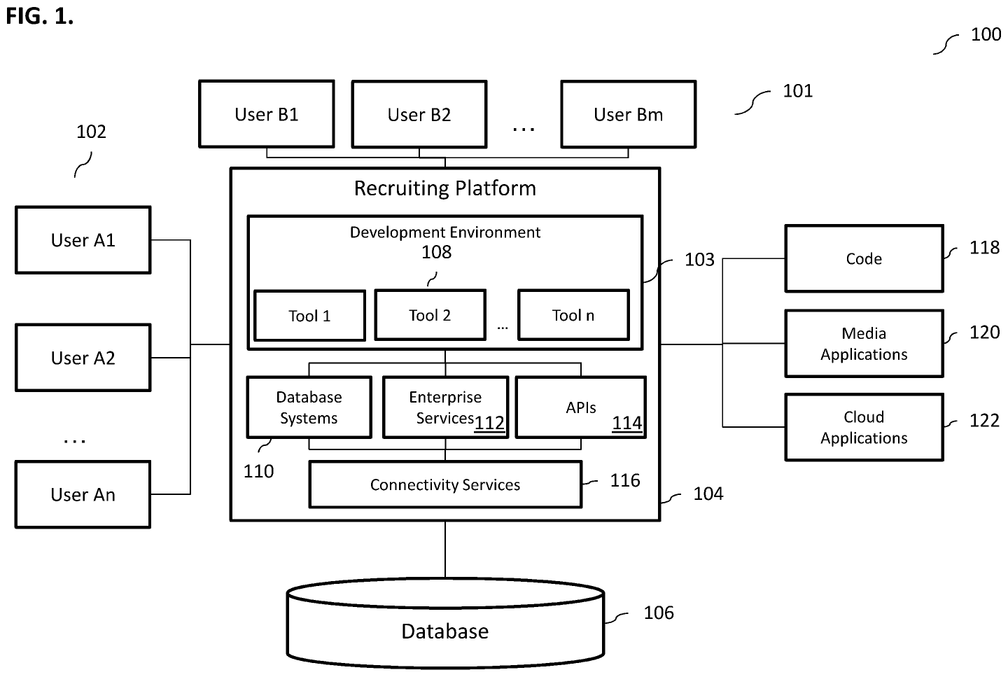

FIG. 1 illustrates an exemplary system 100 for conducting various recruiting activities, according to some implementations of the current subject matter. The system 100 may be configured to operate in one or more clustered computing environments (e.g., Kubernetes), one or more cloud environments, etc. It may include one or more first type of users, entities, applications, etc. 102 (e.g., user A1, user A2, . . . , user An, etc.), which may include one or more interviewer users, administrator users, etc., and one or more second type of users 101 (e.g., user B1, user B2, . . . , user Bm, etc.), which may include one or more prospective candidate users. It may also include a recruiting platform system 104, and a database 106. The system 104 may include one or more computing elements (which may, for example, as discussed below, include one or more processors, one or more servers, one or more computing engines, one or more memory and/or storage locations, one or more databases, etc.) such as, a development environment 103 having one or more computing tools 108, database systems 110, enterprise services 112, application programming interface(s) 114, and connectivity service(s) 116. Further, the system 100 may include one or more code hubs and/or databases 118, one or more media applications 120, and/or one or more cloud applications 122. Various components of the system 100 may be communicatively coupled using various communication protocols, including but not limited to REST protocol, HTTP protocol, etc.

The system 104 may include a processor, a memory, and/or any combination of hardware/software, and may be configured to allow one or more users 102 to communicate with one or more users 101 for the purposes of interviewing the users 101 and/or assigning users 101 specific tasks that may be completed by users 101 using one or more elements of the system 100. The tasks may seek the users 101 to generate one or more or specific software applications, one or more computing processes, one or more computing steps that may be executed by one or more processors, along with any associated data and/or content, and/or any configuration data that may specify one or more functions and/or features of the software application(s), data and/or content. A completed task may include one or more other tasks and/or sub-tasks. In some cases, a completed task may be configured to rely on data, functions and/or features (and/or any combination thereof) of a computing component such that the completed task is an integration and/or a combination of one or more computing components. The user 101 may use one or more computing components that may refer to a software code that may be configured to perform a particular function, a piece and/or a set of data (e.g., data unique to a particular user and/or data available to a plurality of users) and/or configuration data used to create, modify, etc. one or more software functionalities associated with a particular task, sub-task, and/or a portion of a task that may be assigned to a user 101 by one or more users 102. The system 104 may include one or more artificial intelligence and/or learning capabilities that may rely on and/or use various data, e.g., data related to and/or identifying one or more qualifications of users 101 based on the completion of assigned tasks as viewed in the context of historical data associated with completion of tasks by other users.

The elements of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Moreover, the elements of the system 100 may include any combination of hardware and/or software. In some implementations, the elements may be disposed on one or more computing devices, such as, server(s), database(s), personal computer(s), laptop(s), cellular telephone(s), smartphone(s), tablet computer(s), and/or any other computing devices and/or any combination thereof. In some implementations, the elements may be disposed on a single computing device and/or can be part of a single communications network. Alternatively, the elements may be separately located from one another.

The user 102 may be an end user (e.g., a business user), and/or an administrator user. The end user 102 may be configured to use various tools that may be available to the user 102 in screening particular candidate users 101. The users 102 may be configured to cause (e.g., via one or more user interfaces associated with development environment 108) generation one or more tasks for user 101 to resolve.

The development environment 103 may be configured to be structured as a browser-based computing environment. It may be configured to provide a collaborative platform for conducting technical interviews in a browser, thereby making it easy to conduct screening of candidates across various geographical regions, time zones, etc. The environment 103 may be configured to allow users 101 (e.g., prospective candidates) to write code, support code execution in the environment (e.g., browser), perform debugging, and/or perform any other functions. In the environment, a user of a debugger may help identify one or more issues in the written code.

The development environment 103 may be configured support use of one or more tools 108, which may include one or more software applications, functionalities, functions, databases, etc. The tools 108 may be used by one or more users 101 to generate a response to one or more tasks that may be assigned to them by the users 102. The tools 108 may include, for example, a drawing tool, which may be used in drawing a system design, documenting system architecture, technical concepts, etc. This tool may be used to respond to a request to generate a system diagram and/or for any other purpose.

The tools 108 may also include various technologies/programming languages packages. Some example technologies may include technologies available from SAP SE, Walldorf, Germany, e.g., CAP, RAP, SAPUI5, Fiori, mobile-dev-kit (mdk), SAP BTP SDK and others. Examples of programming language tools 108 may include, but are not limited to, JAVA, Python, NodeJS, etc. The users 102 may also utilize one or more tools 108, such as, for the purposes of providing questions, requests, etc. to users 101. The users 102 may obtain questions from one or more question library tools 108 and/or database 106. The question library tools may include, but are not limited to, questions menus, case studies, and others. The users 102 may also utilize one or more user interfaces for using and/or managing the question library tools 108. The tools 108 may also be configured to be provided by one or more database systems 110 (e.g., High Performance Analytic Appliance (“HANA”) system as developed by SAP SE, Walldorf, Germany), one or more enterprise services 112 (e.g., enterprise resource planning (“ERP”) systems, supply chain management system (“SCM”) systems, supplier relationship management (“SRM”) systems, customer relationship management (“CRM”) systems, and/or others). One or more application programming interfaces 114 may be configured to provide appropriate connections, calls, etc. between various tools, services, etc.

In some implementations, users 101, in preparing a response to one or more tasks provided to them by users 102, may utilize source code libraries 118 (e.g., Github), which may include source code repositories, databases, and/or other code storage locations. The source code library may be located behind a firewall, such as, at a secure on-premise enterprise network. One or more connectivity services 116 may be utilized for connection to the source code libraries 118. The connectivity services 116 may be configured to implement various communication protocols, such as, for example, REST, HTTP, etc.

Similarly, users 101, in preparation of a response to the tasks posed to them by users 102, may be configured to access one or more cloud-based applications 122. The connectivity services 116 may likewise provide connections between the development environment 103 and the cloud applications 122. The connections may also be provided by one or more of the above communication protocols.

Additionally, in some implementations, the users 102 may wish to provide various questions (e.g., using graphical flash cards, computer prompts, and/or in any other way) to users 101. Further, the users 102 may also wish to conduct a live meeting with one or more users 101. These may be accomplished using one or more media applications 120 (e.g., which may include a live video conferencing software, internet-based conferencing applications, etc.).

In some implementations, once the users 101 have completed tasks that may be assigned to them (e.g., writing code, responding to questions, providing various information, etc.), the users 101 may verify information that has been prepared prior to submission. Verification of the information may include compilation of any code written, checking of one or more database data (e.g., publicly available databases) to ensure that the data that they provided is correct, etc. Further, the users 101 may be configured to authorize use of their information in performing various checks by the users 102 (e.g., running of background checks, financial checks, etc.). Once these actions are completed, the users 101 may submit the information to the users 102 using the development environment 103.

Upon receiving the information from the users 101 (or while receiving information from users 101, such as, during live video conferences), the users 102 may be configured to submit their feedback regarding tasks and/or any information, data, etc. provided by users 101. The feedback may include, but is not limited to, evaluations of users 101's performance of tasks assigned to them, grading of performance of users 101 in response to various questions, assessment of users 101 qualifications, and/or any other feedback. One or more templates may be utilized for these purposes. Additionally, the users 102 may generate various actions, including preparation and forwarding of standard/customized offer of employment letters to users 101, requests for additional information, onboarding of new hires, etc.

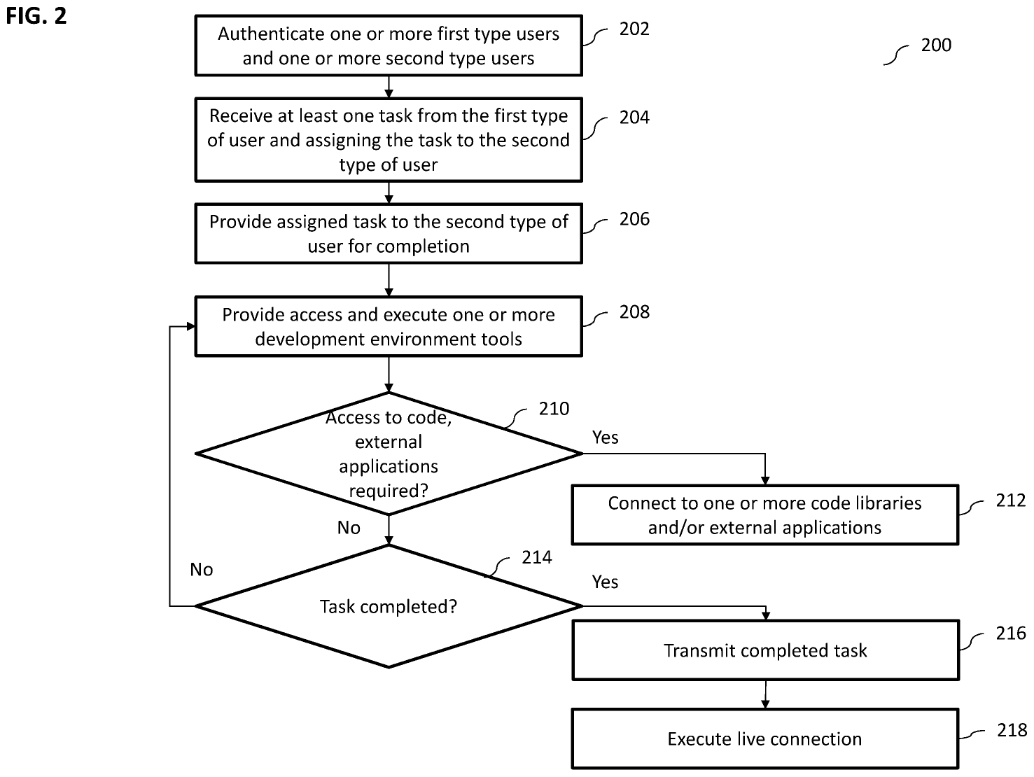

FIG. 2 is a flow chart illustrating an exemplary process 200 for operating the development environment, according to some implementations of the current subject matter. The process 200 may be executed by one or more elements of the system 100. In particular, the recruiting platform 104 may be configured to perform one or more operations of the process 200

At 202, the recruiting platform 104 may be configured to perform authentication of one or more first type of users (e.g., users 102) and one or more second type of users (e.g., users 101). Authentication may be performed using any desired means, such as, for example, individual user name and password, one-time login tokens. Upon authentication, both types of users (e.g., users 101, 102) may be configured to login to an interface associated with the development environment 103 of the recruiting platform 104. The development environment's interface may configured to be browser-based without requiring any separate installations on users' machines. Alternatively, or in addition, the browser interface may be configured as a temporary and/or session-based plug-in that may be generated for the purposes of conducting communications between users 101 and 102 and may be automatically deleted upon completion of communications and/or any sessions between users 101 and 102. The users 101 and 102 may be configured to be securely connected to the development environment 103 using any desired communication protocols (e.g., REST, HTTP, etc.) and/or any interfaces.

At 204, the development environment 103 may be configured to receive one or more tasks from the first type of users (e.g., users 102) and assign them for completion to the second type of users (e.g., users 101). The tasks may include, but are not limited to, writing code associated with a particular software application, functionality, function, etc. that may be aimed to resolve a particular issue, answering questions from user 102, drawing a system, an architecture, etc. diagram, and/or performing any other task. The development environment 103 may be configured to use information that may be exchanged during connection of the users 101 and 102 to determine how to assign tasks from which first type users to which second type users. In some implementations, one or more first type users 102 may be configured to be connected (e.g., interviewing) multiple second type users 101 at the same time. As such, to ensure that tasks are assigned to the correct users 101, the development environment 103 may be configured to use one or more unique identifiers corresponding to the established connections between users 101 and 102 in assignment of the tasks.

At 206, the development environment 103 may be configured to provide and/or transmit the assigned task to the second type of user (e.g., user 101) for completion. To complete the assigned tasks, the user 101 may require access to one or more tools 108 of the development environment 103. For example, the user 101 may have been assigned a task to prepare a computing architecture diagram. In that regard, the user 101 may require use of a drawing tool 108 and an appropriate drawing interface. Upon receiving a request for a particular tool 108, the development environment 103 may be configured to provide access to the user 101 to such tool 108, at 208. The tool may also be executed by the development environment 103, thereby allowing the user 101 to perform the task that has been assigned to the user 101.

At 210, the development environment 103 may be configured to determine whether access to one or more code libraries 118 (e.g., external to the development environment 103) and/or applications 122 may be required for the purposes of completing the assigned task. The development environment 103 may be configured to determine that such access is required upon analyzing the assigned task (e.g., the request may call for generation of a graphical representation of an object, which may require access to a graph API application). Alternatively, or in addition, the development environment 103 may receive specific requests from users 101 and/or 102 for providing such access.

If access to code library 118 and/or applications 122 is required, the recruiting platform 104 and/or the development environment may execute one or more connectivity services 116 to connect the user 101 to such code libraries 118 and/or applications 122, at 212. The code from code libraries 118 and/or an application from applications 122 may be provided to the user 101 via the browser interface associated with the environment 103. If access is not required, the process 200 may be configured to proceed to operation 214.

At 214, the development environment 103 may be configured to determine whether the user 101 has completed the assigned task. Completion of the assigned task may be determined by detecting lack of errors after execution of a compilation function. The development environment 103 may also determine whether task has been completed upon detecting of activation of a save and/or submit button by the user 101 using which the user may save and submit user's work product to user 102. This process may be executed periodically, upon request from user 102, and/or at any desired time. Otherwise, the development environment 103 may continue checking whether the assigned task has been completed and continue providing access to tools 108, code 118, and/or applications 122.

Once the environment 103 has detected completion of the assigned task, the environment 103 may be configured to transmit the completed task to the user 102 for review. In some implementations, the environment 103 may be configured to receive a request from the user 102 and/or user 101 for a live connection between users. For execution of such connection, one or more connectivity services 116 may be executed and one or more media applications 120 may be accessed to provide the requested connection, at 218.

In some implementations, the current subject matter may be implemented in various in-memory database systems, such as a High Performance Analytic Appliance (“HANA”) system as developed by SAP SE, Walldorf, Germany. Various systems, such as, enterprise resource planning (“ERP”) system, supply chain management system (“SCM”) system, supplier relationship management (“SRM”) system, customer relationship management (“CRM”) system, and/or others, may interact with the in-memory system for the purposes of accessing data, for example. Other systems and/or combinations of systems may be used for implementations of the current subject matter. The following is a discussion of an exemplary in-memory system.

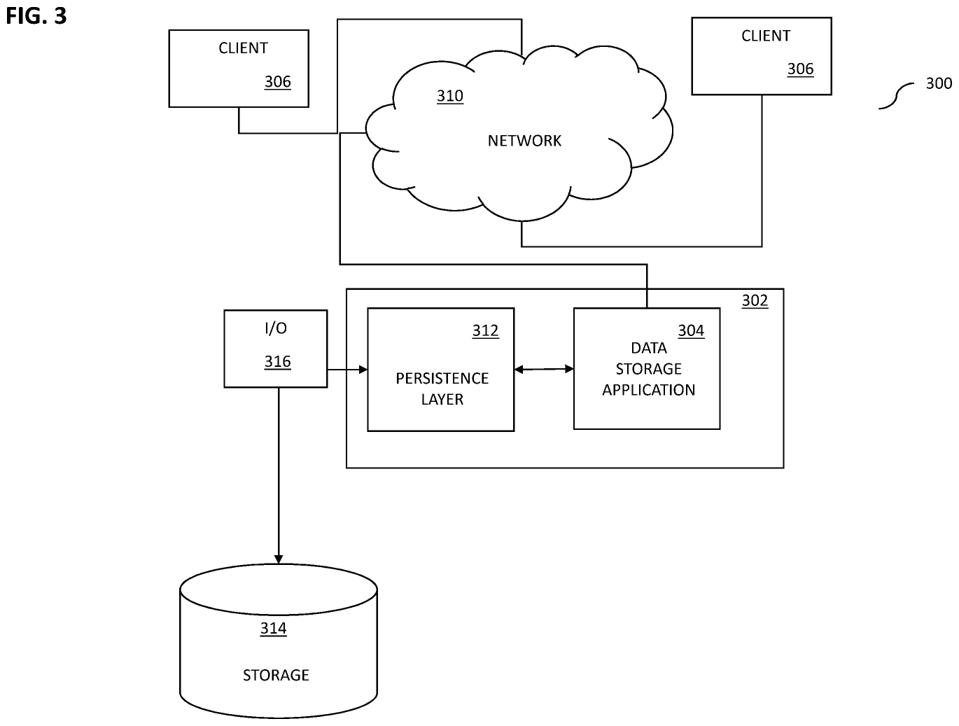

FIG. 3 illustrates an exemplary system 300 in which a computing system 302, which may include one or more programmable processors that may be collocated, linked over one or more networks, etc., executes one or more modules, software components, or the like of a data storage application 304, according to some implementations of the current subject matter. The data storage application 304 may include one or more of a database, an enterprise resource program, a distributed storage system (e.g. NetApp Filer available from NetApp of Sunnyvale, Calif.), or the like.

The one or more modules, software components, or the like may be accessible to local users of the computing system 302 as well as to remote users accessing the computing system 302 from one or more client machines 306 over a network connection 310. One or more user interface screens produced by the one or more first modules may be displayed to a user, either via a local display or via a display associated with one of the client machines 306. Data units of the data storage application 304 may be transiently stored in a persistence layer 312 (e.g., a page buffer or other type of temporary persistency layer), which may write the data, in the form of storage pages, to one or more storages 314, for example via an input/output component 316. The one or more storages 314 may include one or more physical storage media or devices (e.g. hard disk drives, persistent flash memory, random access memory, optical media, magnetic media, and the like) configured for writing data for longer term storage. It should be noted that the storage 314 and the input/output component 316 may be included in the computing system 302 despite their being shown as external to the computing system 302 in FIG. 3.

Data retained at the longer term storage 314 may be organized in pages, each of which has allocated to it a defined amount of storage space. In some implementations, the amount of storage space allocated to each page may be constant and fixed. However, other implementations in which the amount of storage space allocated to each page may vary are also within the scope of the current subject matter.

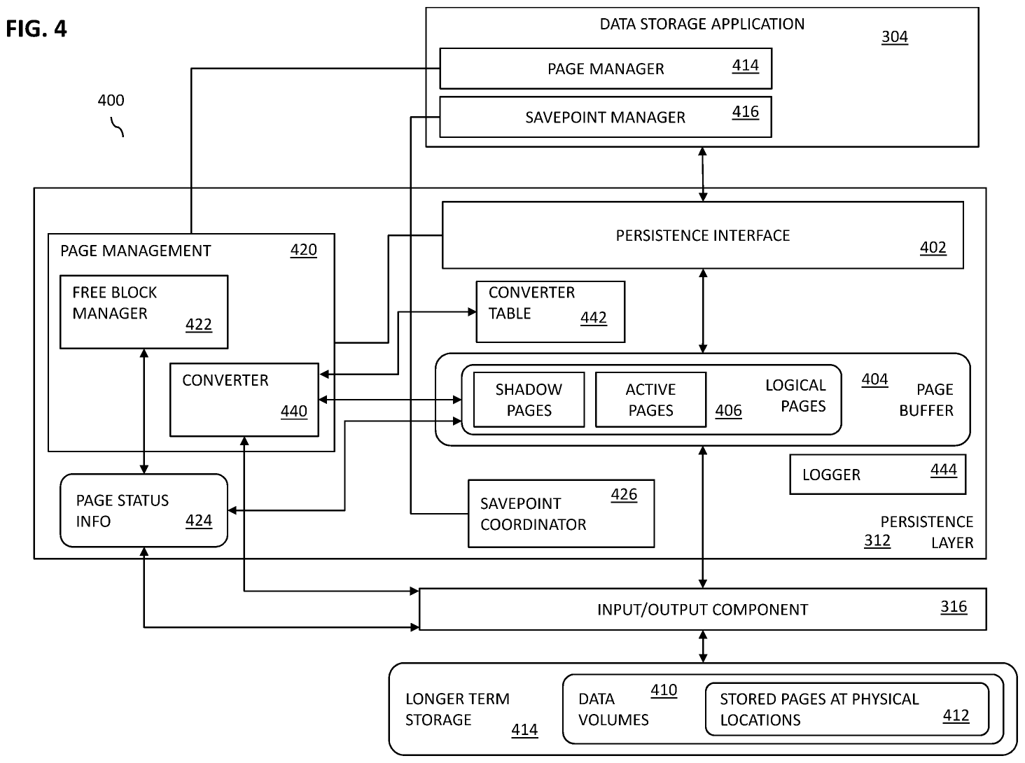

FIG. 4 illustrates exemplary software architecture 400, according to some implementations of the current subject matter. A data storage application 304, which may be implemented in one or more of hardware and software, may include one or more of a database application, a network-attached storage system, or the like. According to at least some implementations of the current subject matter, such a data storage application 304 may include or otherwise interface with a persistence layer 312 or other type of memory buffer, for example via a persistence interface 402. A page buffer 404 within the persistence layer 312 may store one or more logical pages 406, and optionally may include shadow pages, active pages, and the like. The logical pages 406 retained in the persistence layer 312 may be written to a storage (e.g. a longer term storage, etc.) 314 via an input/output component 316, which may be a software module, a sub-system implemented in one or more of software and hardware, or the like. The storage 314 may include one or more data volumes 410 where stored pages 412 are allocated at physical memory blocks.

In some implementations, the data storage application 304 may include or be otherwise in communication with a page manager 414 and/or a savepoint manager 416. The page manager 414 may communicate with a page management module 420 at the persistence layer 312 that may include a free block manager 422 that monitors page status information 424, for example the status of physical pages within the storage 314 and logical pages in the persistence layer 312 (and optionally in the page buffer 404). The savepoint manager 416 may communicate with a savepoint coordinator 426 at the persistence layer 312 to handle savepoints, which are used to create a consistent persistent state of the database for restart after a possible crash.

In some implementations of a data storage application 304, the page management module of the persistence layer 312 may implement a shadow paging. The free block manager 422 within the page management module 420 may maintain the status of physical pages. The page buffer 404 may include a fixed page status buffer that operates as discussed herein. A converter component 440, which may be part of or in communication with the page management module 420, may be responsible for mapping between logical and physical pages written to the storage 314. The converter 440 may maintain the current mapping of logical pages to the corresponding physical pages in a converter table 442. The converter 440 may maintain a current mapping of logical pages 406 to the corresponding physical pages in one or more converter tables 442. When a logical page 406 is read from storage 314, the storage page to be loaded may be looked up from the one or more converter tables 442 using the converter 440. When a logical page is written to storage 314 the first time after a savepoint, a new free physical page is assigned to the logical page. The free block manager 422 marks the new physical page as “used” and the new mapping is stored in the one or more converter tables 442.

The persistence layer 312 may ensure that changes made in the data storage application 304 are durable and that the data storage application 304 may be restored to a most recent committed state after a restart. Writing data to the storage 314 need not be synchronized with the end of the writing transaction. As such, uncommitted changes may be written to disk and committed changes may not yet be written to disk when a writing transaction is finished. After a system crash, changes made by transactions that were not finished may be rolled back. Changes occurring by already committed transactions should not be lost in this process. A logger component 444 may also be included to store the changes made to the data of the data storage application in a linear log. The logger component 444 may be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations may occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information may be written by the logger component 444 whenever a change is made. This information may be written to disk at latest when the transaction ends. The log entries may be persisted in separate log volumes while normal data is written to data volumes. With a redo log, committed changes may be restored even if the corresponding data pages were not written to disk. For undoing uncommitted changes, the persistence layer 312 may use a combination of undo log entries (from one or more logs) and shadow paging.

The persistence interface 402 may handle read and write requests of stores (e.g., in-memory stores, etc.). The persistence interface 402 may also provide write methods for writing data both with logging and without logging. If the logged write operations are used, the persistence interface 402 invokes the logger 444. In addition, the logger 444 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 444. For an entry of type “update”, for example, this would be the identification of the affected record and the after image of the modified data.

When the data application 304 is restarted, the log entries need to be processed. To speed up this process the redo log is not always processed from the beginning. Instead, as stated above, savepoints may be periodically performed that write all changes to disk that were made (e.g., in memory, etc.) since the last savepoint. When starting up the system, only the logs created after the last savepoint need to be processed. After the next backup operation the old log entries before the savepoint position may be removed.

When the logger 444 is invoked for writing log entries, it does not immediately write to disk. Instead it may put the log entries into a log queue in memory. The entries in the log queue may be written to disk at the latest when the corresponding transaction is finished (committed or aborted). To guarantee that the committed changes are not lost, the commit operation is not successfully finished before the corresponding log entries are flushed to disk. Writing log queue entries to disk may also be triggered by other events, for example when log queue pages are full or when a savepoint is performed.

With the current subject matter, the logger 444 may write a database log (or simply referred to herein as a “log”) sequentially into a memory buffer in natural order (e.g., sequential order, etc.). If several physical hard disks/storage devices are used to store log data, several log partitions may be defined. Thereafter, the logger 444 (which as stated above acts to generate and organize log data) may load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers may be reordered from log segments of all partitions during recovery to the proper order.

As stated above, the data storage application 304 may use shadow paging so that the savepoint manager 416 may write a transactionally-consistent savepoint. With such an arrangement, a data backup comprises a copy of all data pages contained in a particular savepoint, which was done as the first step of the data backup process. The current subject matter may be also applied to other types of data page storage.

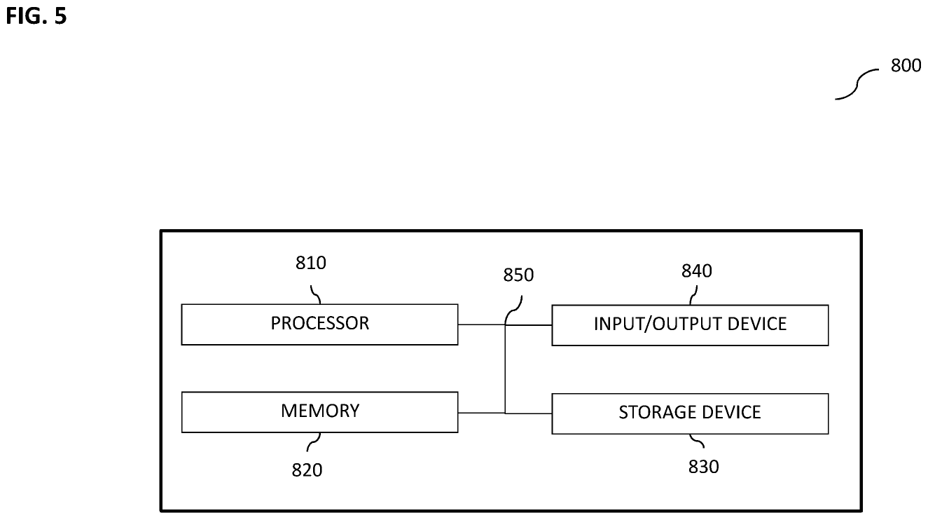

In some implementations, the current subject matter may be configured to be implemented in a system 500, as shown in FIG. 5. The system 500 may include a processor 510, a memory 520, a storage device 530, and an input/output device 540. Each of the components 510, 520, 530 and 540 may be interconnected using a system bus 550. The processor 510 may be configured to process instructions for execution within the system 500. In some implementations, the processor 510 may be a single-threaded processor. In alternate implementations, the processor 510 may be a multi-threaded processor. The processor 510 may be further configured to process instructions stored in the memory 520 or on the storage device 530, including receiving or sending information through the input/output device 540. The memory 520 may store information within the system 500. In some implementations, the memory 520 may be a computer-readable medium. In alternate implementations, the memory 520 may be a volatile memory unit. In yet some implementations, the memory 520 may be a non-volatile memory unit. The storage device 530 may be capable of providing mass storage for the system 500. In some implementations, the storage device 530 may be a computer-readable medium. In alternate implementations, the storage device 530 may be a floppy disk device, a hard disk device, an optical disk device, a tape device, non-volatile solid state memory, or any other type of storage device. The input/output device 540 may be configured to provide input/output operations for the system 500. In some implementations, the input/output device 540 may include a keyboard and/or pointing device. In alternate implementations, the input/output device 540 may include a display unit for displaying graphical user interfaces.

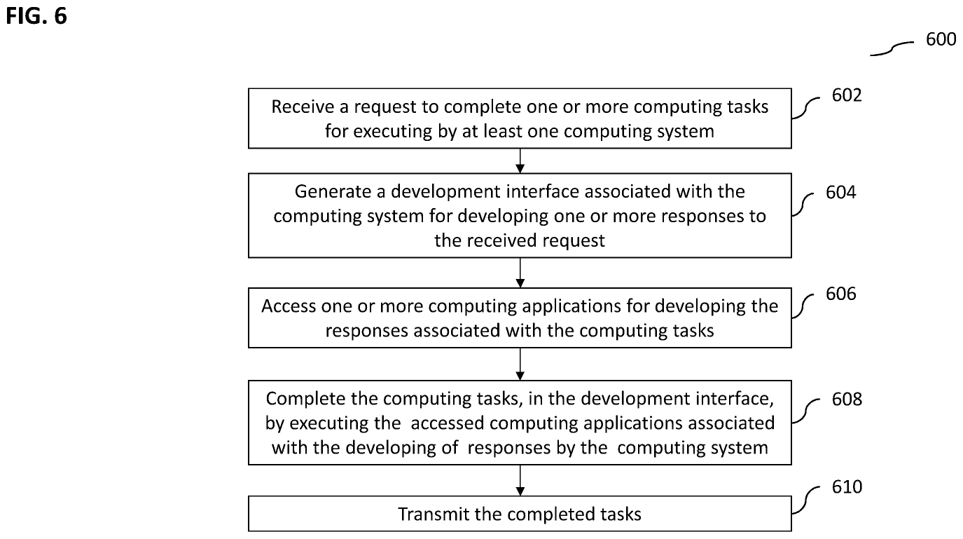

FIG. 6 illustrates an exemplary method 600 for enabling development testing during evaluation processes, according to some implementations of the current subject matter. The method 600 may be performed by the system shown in FIG. 1 and in particular the recruiting platform 104, including its development environment 103, which may be used by the users 101 and 102 during, for example, an interview process.

At 602, a request to complete one or more computing tasks (e.g., write code, answer questions, etc.) for executing by at least one computing system (e.g., system 100 shown in FIG. 1). At 604, a development interface (e.g., development environment 103) associated with the computing system for developing one or more responses to the received request may be generated. A completion of the computing tasks may include the developed responses (e.g., code, answers to questions, etc.).

At 606, one or more computing applications (e.g., tools 108, code 118, cloud applications 122, etc.) for developing the responses associated with the computing tasks may be accessed based on the received request. At 608, the tasks may be completed in the development interface. Completion of tasks may include executing the accessed computing applications associated with the developing of the responses by the computing system. At 610, the completed tasks may be transmitted to the user 102, for example.

In some implementations, the current subject matter may include one or more of the following optional features. The development interface may be a browser-based interface. One or more tasks may include at least one of the following: generating a source code, generating one or more computing functions, generating one or more software applications, generating one or more computing functionalities, providing at least one of a text, graphical, audio, video and image data, and any combination thereof.

In some implementations, accessing may include accessing at least one of the following: one or more source code libraries, one or more computing applications external to the development interface, one or more computing applications internal to the development interface, and any combination thereof for developing one or more responses.

In some implementations, receiving may include receiving, from a first user, the request to complete one or more computing tasks for executing by at least one computing system, and assigning the received request to at least one second user for completion. The method may also include authenticating, using the development interface, the first and second users. In some implementations, the computing system may be a cloud-based computing system.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving a request to complete one or more computing tasks for executing by at least one computing system;
generating a development interface associated with the at least one computing system for developing one or more responses to the received request, a completion of the one or more computing tasks including the developed one or more responses;
accessing, based on the received request, one or more computing applications for developing the one or more responses associated with the one or more computing tasks;
completing the one or more computing tasks, in the development interface, by executing the one or more accessed computing applications associated with the developing of the one or more responses by the at least one computing system; and
transmitting the completed one or more tasks.

2. The method according to claim 1, wherein the development interface is a browser-based interface.

3. The method according to claim 1, wherein the one or more tasks include at least one of the following: generating a source code, generating one or more computing functions, generating one or more software applications, generating one or more computing functionalities, providing at least one of a text, graphical, audio, video and image data, and any combination thereof.

4. The method according to claim 1, wherein the accessing includes accessing at least one of the following: one or more source code libraries, one or more computing applications external to the development interface, one or more computing applications internal to the development interface, and any combination thereof for developing one or more responses.

5. The method according to claim 1, wherein the receiving includes
receiving, from a first user, the request to complete one or more computing tasks for executing by at least one computing system; and
assigning the received request to at least one second user for completion.

6. The method according to claim 5, further comprising authenticating, using the development interface, the first and second users.

7. The method according to claim 1, wherein the at least one computing system is a cloud-based computing system.

8. A system comprising:
at least one programmable processor; and
a non-transitory machine-readable medium storing instructions that, when executed by the at least one programmable processor, cause the at least one programmable processor to perform operations comprising:
receiving a request to complete one or more computing tasks for executing by at least one computing system;
generating a development interface associated with the at least one computing system for developing one or more responses to the received request, a completion of the one or more computing tasks including the developed one or more responses;
accessing, based on the received request, one or more computing applications for developing the one or more responses associated with the one or more computing tasks;
completing the one or more computing tasks, in the development interface, by executing the one or more accessed computing applications associated with the developing of the one or more responses by the at least one computing system; and
transmitting the completed one or more tasks.

9. The system according to claim 8, wherein the development interface is a browser-based interface.

10. The system according to claim 8, wherein the one or more tasks include at least one of the following: generating a source code, generating one or more computing functions, generating one or more software applications, generating one or more computing functionalities, providing at least one of a text, graphical, audio, video and image data, and any combination thereof.

11. The system according to claim 8, wherein the accessing includes accessing at least one of the following: one or more source code libraries, one or more computing applications external to the development interface, one or more computing applications internal to the development interface, and any combination thereof for developing one or more responses.

12. The system according to claim 8, wherein the receiving includes receiving, from a first user, the request to complete one or more computing tasks for executing by at least one computing system; and
assigning the received request to at least one second user for completion.

13. The system according to claim 12, wherein the operations further comprise authenticating, using the development interface, the first and second users.

14. The system according to claim 8, wherein the at least one computing system is a cloud-based computing system.

15. A computer program product comprising a non-transitory machine-readable medium storing instructions that, when executed by at least one programmable processor, cause the at least one programmable processor to perform operations comprising:
receiving a request to complete one or more computing tasks for executing by at least one computing system;
generating a development interface associated with the at least one computing system for developing one or more responses to the received request, a completion of the one or more computing tasks including the developed one or more responses;
accessing, based on the received request, one or more computing applications for developing the one or more responses associated with the one or more computing tasks;
completing the one or more computing tasks, in the development interface, by executing the one or more accessed computing applications associated with the developing of the one or more responses by the at least one computing system; and
transmitting the completed one or more tasks.

16. The computer program product according to claim 15, wherein the development interface is a browser-based interface.

17. The computer program product according to claim 15, wherein the one or more tasks include at least one of the following: generating a source code, generating one or more computing functions, generating one or more software applications, generating one or more computing functionalities, providing at least one of a text, graphical, audio, video and image data, and any combination thereof.

18. The computer program product according to claim 15, wherein the accessing includes accessing at least one of the following: one or more source code libraries, one or more computing applications external to the development interface, one or more computing applications internal to the development interface, and any combination thereof for developing one or more responses.

19. The computer program product according to claim 15, wherein the receiving includes
receiving, from a first user, the request to complete one or more computing tasks for executing by at least one computing system; and
assigning the received request to at least one second user for completion.

20. The computer program product according to claim 19, wherein the operations further comprise authenticating, using the development interface, the first and second users.
